(19) United States
(12) Patent Application Publication
(10) Pub. No.: US 2009/0033048 A1
(43) Pub. Date: Feb. 5, 2009

(54) Advertising Space Applied To Grocery Carts

(76) Inventor: Luiz Aparecido Marquezin, Sao Paulo (BR)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/831,994

(22) Filed: Aug. 1, 2007

(51) Int. Cl. B62D 39/00

(52) U.S. Cl. 280/33.992

(57) ABSTRACT

Reference the following document for an invention patent in relation to an advertising panel applied to grocery carts specifically those in supermarkets, which permits that the user of the cart and the general public that is circulating the store can see the media advertised.

The object of the present patent is to provide an advertising space that permits the user of the cart to have the advertising media displayed to him/her at all times, while simultaneously maintaining the advertising visible to the other patrons of the store.

The new advertising space is formed by a piece that is substantially triangular, allowing for two surfaces that advertising media can be applied too, being that this device is placed in proximity to the cart handle, in such a matter that both surfaces with media stay facing the cart user or circulating public of the store.

### FIELD OF THE INVENTION

The present invention relates to an advertising panel applied to grocery carts specifically those in supermarkets, which permits the user of the cart and the general public that is circulating the store to see the media being advertised.

### BACKGROUND OF THE INVENTION

It is know that there are several methods of advertising in grocery carts; in general they are composed of plates located in the frontal or lateral region of the cart, which display media in its external facet.

This tip of propaganda, besides being used in the interior of stores, such as supermarkets, or in points of purchase, is not visualized by the actual user of the grocery cart, once it is out of his/her line of sight, such as the sides of the grocery cart.

### OBJECTS AND SUMMARY OF THE INVENTION

The object of the present patent is to provide an advertising space that permits the user of the cart to have the advertising media displayed to him/her at all times, while simultaneously maintaining the advertising visible to the other patrons of the store.

The new advertising space is formed by a piece that is substantially triangular, allowing for two surfaces that advertising media can be applied too, being that this device is placed in proximity to the cart handle, in such a matter that both surfaces with media stay facing the cart user or circulating public of the store.

### DESCRIPTION OF THE DRAWINGS

Below the invention will be described by use of the following attached drawings in which:

FIG. 1—represents the advertising panel the object of the patent seen from a top view;

FIG. 2—represents the advertising panel the object of the patent seen from an inferior angle; A

FIG. 3—represents the advertising panel the object of the patent seen in a diagramed from;

FIG. 4—demonstrates a transversal cut in the advertising panel

FIG. 5—demonstrates an inferior diagramed view of the advertising panel

FIG. 6—shows a picture of the advertising panel attached to a grocery cart.

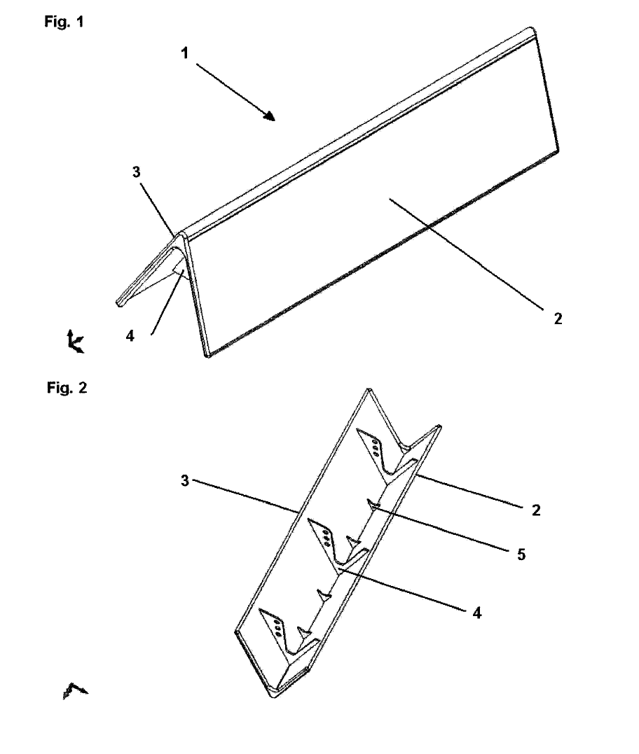

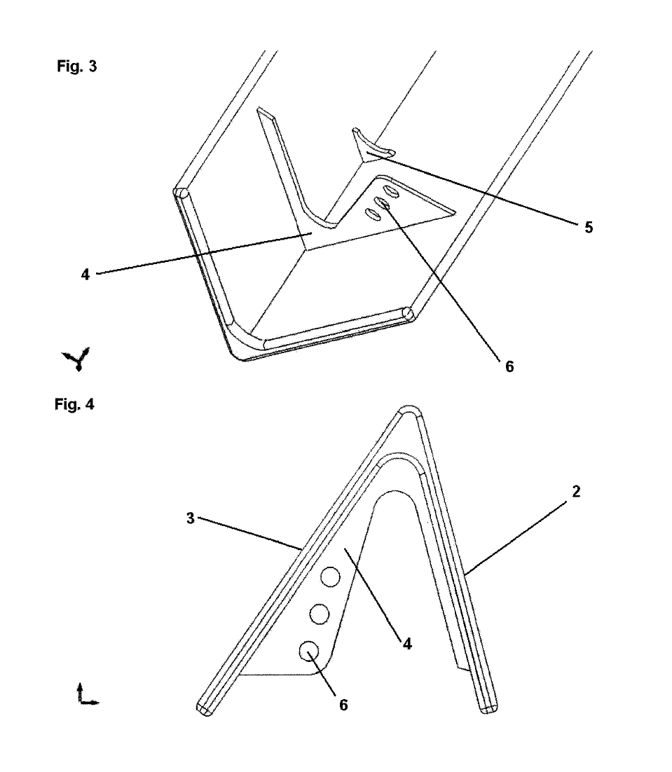

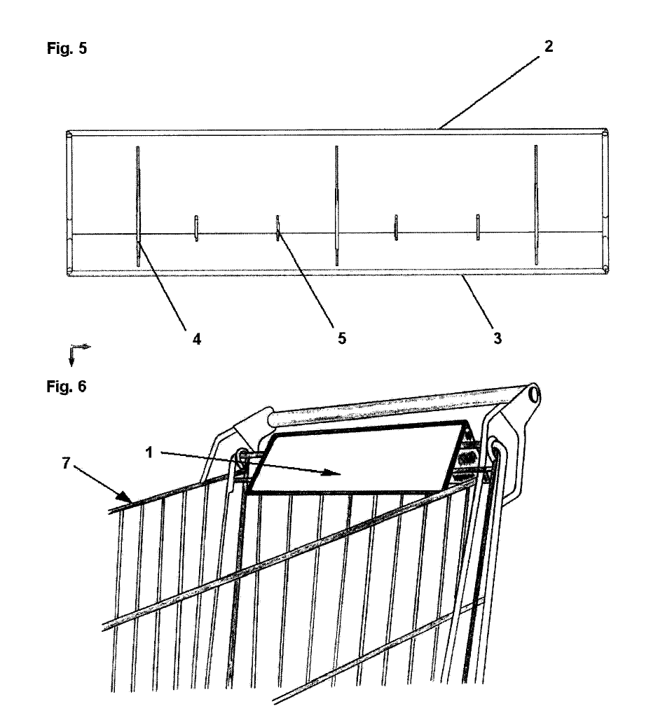

### DETAILED DESCRIPTION OF THE INVENTION

The new advertising panel (1) applied to a grocery cart (7) with the handle in such a way that the device faces (2) toward the user of the cart and the other face (3) stays pointed towards the grocery cart, were it can be visualized by other individuals.

The advertising panel is composed of two plaques (2) and (3) of bent, or injected, or glued to one another, in such a manner to were they from an angle between 25° and 60°, whereas the aforementioned patents are connected by reinforcing structures (4) (5), these reinforcing structures also act as support and attachment pieces to the actual grocery cart.

The reinforcing structures (4) are formed in a “V” shape, forming two struts, were the region of the vertices has a curvature that allow it to be supported by the grocery cart.

The structural elements (4) made up of struts contain orifices (6) that allow the piece the advertising panel to be attached (1) to the grocery cart (7), by means of a tie such as a zip tie, this allows for the removal or replacement of the advertising panel for another such panel.

The reinforcing structures (5) are also in the form of a “V” by are smaller in size, these structural elements are applied with the intent of giving rigidity to the advertising panel.

The advertising panels (1) plates (2) and (3) can receive advertising media, this media can be applied directly to the surface, for example through use of a silk-screen, or one can apply adhesive based media to the plate itself, which can later be removed, in such a way that the advertising is displayed to the cart user and to the general public.

1-12. (canceled)

13. An apparatus for displaying advertising on a grocery cart having a handle, which comprises a “V”-shaped advertising panel (1) displayed in an upper region of the grocery cart (7) near the handle and having at least one surface suitable to receive advertising thereon.

14. The apparatus of claim 13, wherein the panel is formed by a bent piece that creates two areas (2) and (3).

15. The apparatus of claim 13, wherein the panel is formed by two molded plates creating two areas (2) and (3)

16. The apparatus of claim 13, wherein the panel is formed by injecting the plates creating two areas (2) and (3)

17. The apparatus of claim 13, wherein the plates or areas (2) and (3) are interconnected by elements.

18. The apparatus of claim 13, wherein advertising panel (1) is formed by a manufactured piece that creates two areas (2) and (3)

19. The apparatus of claim 18, wherein the manufactured advertising panel (1) will receive a finish suitable to create a smooth outer coating, creating the area where the advertising will be applied.

20. The apparatus of claim 14, wherein the plates or areas (2) and (3) are positioned at an angle between 25° and 60° from each other.

21. The apparatus of claim 13, wherein the plates or areas (2) and (3) are interconnected by structural elements (4).

22. The apparatus of claim 13, wherein the plates or areas (2) and (3) are interconnected by structural elements (5)

23. The apparatus of claim 13, wherein elements (4) and (5) are elements of attachment to the grocery cart.

24. The apparatus of claim 23, wherein the element of fixation of the panel (1) to the grocery cart (7) comprises a tie attached to at least one of the orifices (6) of each structural element (4).
